(19) United States
(12) Patent Application Publication
(10) Pub. No.: US 2014/0268849 A1
(43) Pub. Date: Sep. 18, 2014

(54) VEHICLE LIGHTING UNIT

(71) Applicant: Stanley Electric Co., Ltd., Tokyo (JP)

(72) Inventor: Hiroaki Moriya, Tokyo (JP)

(73) Assignee: Stanley Electric Co., Ltd., Tokyo (JP)

(21) Appl. No.: 14/218,040

(22) Filed: Mar. 18, 2014

(30) Foreign Application Priority Data
Mar. 18, 2013 (JP) 2013-055133

(51) Int. Cl. F21S 8/10

(52) U.S. Cl. CPC F21S 48/1376; F21S 48/125
USPC 362/516

(57) ABSTRACT

A vehicle lighting unit can be provided to maintain a basic design without design limitation and to show the color change of the reflector in a gradation manner, when the lighting unit is turned off, with a simple configuration. The vehicle lighting unit such as a positioning lamp can include a housing, an outer lens covering the opening section thereof, the outer lens defining a lighting chamber together with the housing; a light source (bulb); and a reflector having a dummy section where light from the light source does not reach, the light source and the reflector being housed in the lighting chamber. In this configuration, a plurality of slit-like holes are formed in the dummy section of the reflector at appropriate intervals in a direction of a vehicle width so as to have a size increased gradually as it is positioned more outward in the vehicle width direction.

This application claims the priority benefit under 35 U.S.C. §119 of Japanese Patent Application No. 2013-055133 filed on Mar. 18, 2013, which is hereby incorporated in its entirety by reference.

1. Technical Field

The presently disclosed subject matter relates to a vehicle lighting unit that can include a reflector having a dummy section configured not to function as a light emission section.

2. Background Art

Vehicle lighting units used as a headlamp, positioning lamp, and the like vehicle lamp to be disposed on front right and left portions of a vehicle body can be configured to include a housing and an outer lens covering the opening of the housing, which can define a lighting chamber, and a light source and a reflector configured to reflect light from the light source, which are housed in the lighting chamber.

Some of such vehicle lighting units can be configured to include a dummy section that is provided to the reflector and does not function as a light emission section (being an ineffective section where the light from the light source does not reach) due to vehicle body designs or the like. In this type of vehicle lighting unit, if the outer lens is transparent, the reflector can be seen from outside as see-through state. Thus, in order to provide an aesthetic appearance to the vehicle lighting unit when the unit is turned off and visually observed, the dummy section may also be provided with a dummy reflector like in the light emission section. (See, for example, Japanese Patent Application Laid-Open No. 2000-173318.)

In general, the housing can be molded with a black-colored resin and the reflection surface of the reflector is subjected to a reflection treatment such as aluminum vapor deposition. Thus, the dummy section of the reflector can be configured to be observed by varying the color of silver to black in a gradation manner when the vehicle lighting unit is turned off. How to vary the color from the dummy section to its outer side may include the following two methods, for example.

Specifically, one is a method of providing a lens cut to the outer lens to utilize the color of the housing (black color) to make the portion have the color of silver to black in a gradation manner, and the other one is a method of coating the dummy reflection surface of the reflector with the same color as that of the housing (black) in an alternate manner to show the gradation.

The former method, however, has a problem in that the design of the vehicle lighting unit as a whole may deteriorate or be limited due to the lens cut provided to the outer lens.

The latter method has a problem in that the manufacturing costs may be increased due to the complicated costly method (providing masking in an alternate manner to the reflection surface (aluminum deposition surface) of the reflector).

### SUMMARY

The presently disclosed subject matter was devised in view of these and other problems and features in association with the conventional art. According to an aspect of the presently disclosed subject matter, a vehicle lighting unit can be provided to maintain the basic design without design limitation and to show the color change of the reflector in a gradation manner with a simple configuration when the vehicle lighting unit is turned off.

According to another aspect of the presently disclosed subject matter, a vehicle lighting unit can include a housing having an opening section and an outer lens covering the opening section thereof, that can define a lighting chamber together, and a light source and a reflector having a dummy section where light from the light source does not reach, that are housed in the lighting chamber, wherein a plurality of slit-like holes are formed in the dummy section of the reflector at appropriate intervals in a direction of a vehicle width so as to have a size increased gradually as it is positioned more outward in the vehicle width direction.

In the vehicle lighting unit with the above configuration, at least the dummy section of the reflector can be disposed in front of the housing in a direction in which the light from the light source is emitted.

According to another aspect of the presently disclosed subject matter, in the vehicle lighting unit with the above configuration, at least the dummy section of the reflector can be disposed at or substantially near the housing in a direction in which the light from the light source is emitted.

Alternatively, in the vehicle lighting unit with the above configuration, at least the dummy section of the reflector can be disposed in rear of the housing in a direction in which the light from the light source is emitted.

With the configuration above, the dummy section of the reflector in the vehicle lighting unit when turned off can be seen with a color gradation of alternate two colors, silver (deposited Al color) and black of the reflection surface of the reflector and the housing through the plurality of slit-shaped holes formed in the dummy section of the reflector. In this case, the size of the plurality of slit-shaped hole can be designed to increase as it is positioned more outward in the vehicle width direction. This configuration can naturally change the color of the reflection surface of the reflector from the reflector color (silver) to the housing color (black), resulting in natural color change between the reflector and the peripheral part, i.e., the housing without a feeling of strangeness. When the vehicle lighting unit is turned on, the lighting unit can be observed due to the provision of the plurality of slit-like holes provided to the dummy section of the reflector as if the entire lighting unit in the width direction can emit light.

Furthermore, this can be achieved only by the simple structure formed by the slit-like holes in the dummy section of the reflector, resulting in achievement of cost reduction. Since the formation of lens cuts to the inner lens and the like is not required, the basic design of the vehicle lighting unit may not deteriorate and the design is not limited more than necessary.

### BRIEF DESCRIPTION OF DRAWINGS

These and other characteristics, features, and advantages of the presently disclosed subject matter will become clear from the following description with reference to the accompanying drawings, wherein:

FIG. 1 is a horizontal cross-sectional view illustrating a vehicle lighting unit made in accordance with principles of the presently disclosed subject matter;

FIG. 2 is an enlarged cross-sectional view illustrating the essential part of FIG. 1;

FIG. 3 is a perspective view illustrating a reflector of the vehicle lighting unit of FIG. 1;

FIG. 4 is a horizontal cross-sectional view of an essential part of a vehicle lighting unit according to another exemplary embodiment made in accordance with the principles of the presently disclosed subject matter; and

FIG. 5 is a horizontal cross-sectional view of an essential part of a vehicle lighting unit according to still another exemplary embodiment made in accordance with the principles of the presently disclosed subject matter.

### DESCRIPTION OF EXEMPLARY EMBODIMENTS

A description will now be made below to vehicle lighting units of the presently disclosed subject matter with reference to the accompanying drawings in accordance with exemplary embodiments.

FIG. 1 is a horizontal cross-sectional view illustrating a vehicle lighting unit made in accordance with the principles of the presently disclosed subject matter, FIG. 2 is an enlarged cross-sectional view illustrating the essential part of FIG. 1;, and FIG. 3 is a perspective view illustrating a reflector of the vehicle lighting unit of FIG. 1. The vehicle lighting unit 1 of the present exemplary embodiment can be a positioning lamp to be disposed in front left and right portions of a vehicle body. The configuration of positioning lamp 1 is the same for both the right side lamp and the left side lamp (provided in a line symmetric manner), and accordingly, one of them will be described hereinafter.

As shown in FIG. 1, the positioning lamp 1 according to the present exemplary embodiment can include a housing 2 having an opening section, and an inner lens 3 and an outer lens 4 configured to cover the opening section, which can define a lighting chamber 5 together. The positioning lamp 1 can include a bulb 6 serving as a light source and a reflector 7 configured to reflect light from the bulb 6, which are housed in the lighting chamber 5.

The housing 2 can be formed from an opaque black resin and integrally molded as an elongated box shape in the vehicle width direction (in the left-to-right direction in FIG. 1). The housing 2 can have an opening section. The inner lens 3 and the outer lens 4 can cover the opening section, and can be integrally molded using a transparent resin in a horizontally elongated shape with an arch-like curved surface.

As illustrated in FIG. 3, a circular hole 8 can be formed in the reflector 7 on the inner side in the vehicle width direction, so that the bulb 6 can be inserted therethrough. The reflector 7 can include a plurality of strip-shaped reflection surfaces 7a and 7b elongated in the vertical direction, each of which is formed by bending molding to be protruded forward. These reflection surfaces 7a and 7b can constitute the light emission section where the light from the bulb 6 reaches. A dummy section can be provided in the reflector on the outer side in the vehicle width direction where the light from the bulb 6 does not reach. The dummy section can include a plurality of slit-like holes 7c vertically elongated so as to allow light from the bulb 6 to pass therethrough. The plurality of elongated holes 7c can be formed to be positioned at appropriate intervals in the vehicle width direction. The reflection surfaces 7a and 7b can be subjected mirror finishing, or reflection treatment, such as aluminum deposition.

Specifically, the dummy section of the reflector 7 can include the plurality of slit-like holes 7c vertically elongated and positioned at appropriate intervals in the vehicle width direction so as to have a width size increased gradually as it is positioned more outward in the vehicle width direction (from the right side to the left side in FIGS. 1 to 3).

With this configuration, when the positioning lamp 1 is not turned on, as illustrated by solid arrows in FIG. 2, the light L1 can pass through the plurality of slit-like holes 7c formed in the dummy section of the reflector 7 and reach the housing 2. Then, the light can be reflected off the inner face of the housing to be observed as being black. On the other hand, the light L2 that does not pass through the holes 7c as illustrated by dotted arrows in FIG. 2 can be reflected by the reflection surface 7b to be observed as being silver (totally reflected original light color). Accordingly, the dummy section of the reflector 7 can be observed to provide a gradation by alternately showing silver of the reflection surface color and black of the housing color. In this case, the size of the plurality of slit-like holes 7c can be designed to be gradually increased as it is positioned more outward in the vehicle width direction, and accordingly, when the dummy section of the reflector 7 is observed, the color of the dummy section can be naturally changed from silver color of the reflection surface 7b of the reflector 7 to black color of the housing 2. As a result, the color can be naturally changed between the reflector 7 and the peripheral part, i.e., the housing 2 without a feeling of strangeness. When the positioning lamp 1 is turned on, the lighting unit can be observed due to the provision of the plurality of slit-like holes 7c provided to the dummy section of the reflector 7 as if the entire lighting unit in the width direction can emit light.

Furthermore, this can be achieved only by the simple structure formed by the slit-like holes 7c in the dummy section of the reflector 7, resulting in achievement of cost reduction. Since the formation of lens cuts to the inner lens 3 and the like is not required, the basic design of the positioning lamp 1 may not deteriorate and the design is not limited more than necessary.

In the above exemplary embodiment, the dummy section of the reflector 7 is disposed in front of the housing 2. However, the presently disclosed subject matter is not limited thereto. For example, as illustrated in the horizontal cross-sectional view of FIG. 4, the housing 2 can be formed to include a plurality of concave sections 2a and convex sections 2b alternately formed therein, and the convex sections 2b can be fit to the plurality of holes 7c formed in the dummy section of the reflector 7, so that the surfaces of the convex sections 2b of the housing 2 and the dummy section (reflection surface 7b) of the reflector 7 can be flush with each other (disposed at the same level position in the front-to-rear direction). In still another exemplary embodiment, the convex sections 2b of the housing 2 can be allowed to penetrate through the hole 7c, so that the dummy section (reflection surface 7b) of the reflector 7 can be disposed in rear of the housing 2 in the front-to-rear direction.

Further, the presently disclosed subject matter has been described as a positioning lamp, but it is not limited thereto. Various vehicle lighting units having such a dummy section formed in a reflector can utilize the configuration made in accordance with the principles of the presently disclosed subject matter.

It will be apparent to those skilled in the art that various modifications and variations can be made in the presently disclosed subject matter without departing from the spirit or scope of the presently disclosed subject matter. Thus, it is intended that the presently disclosed subject matter cover the modifications and variations of the presently disclosed subject matter provided they come within the scope of the appended claims and their equivalents. All related art references described above are hereby incorporated in their entirety by reference.

What is claimed is:

1. A vehicle lighting unit comprising:
a housing having an opening section;
an outer lens covering the opening section thereof, the outer lens defining a lighting chamber together with the housing;
a light source; and
a reflector having a dummy section where light from the light source does not reach, the light source and the reflector being housed in the lighting chamber, wherein
a plurality of slit-like holes are formed in the dummy section of the reflector at appropriate intervals in a direction of a vehicle width so as to have a size increased gradually as it is positioned more outward in the vehicle width direction.

2. The vehicle lighting unit according to claim 1, wherein at least the dummy section of the reflector is disposed in front of the housing in a direction in which the light from the light source is emitted.

3. The vehicle lighting unit according to claim 1, wherein at least the dummy section of the reflector is disposed at or substantially near the housing in a direction in which the light from the light source is emitted.

4. The vehicle lighting unit according to claim 1, wherein at least the dummy section of the reflector is disposed in rear of the housing in a direction in which the light from the light source is emitted.
